(19) United States
(12) Patent Application Publication
(10) Pub. No.: US 2013/0303107 A1
(43) Pub. Date: Nov. 14, 2013

(54) Location Determination of a Roaming Subscriber Device Using SMS for Emergency Purposes

(71) Applicant: Telecommunication Systems, Inc., Annapolis, MD (US)

(72) Inventors: Donald L. Mitchell, JR., Bellevue, WA (US); Roger S. Marshall, Auburn, WA (US); Mark A. Titus, Annapolis, MD (US)

(21) Appl. No.: 13/891,632

(22) Filed: May 10, 2013

Related U.S. Application Data
(60) Provisional application No. 61/645,366, filed on May 10, 2012.

(51) Int. Cl. H04W 4/14

(52) U.S. Cl. CPC H04W 4/14
USPC 455/404.2

(57) ABSTRACT

Location determination for a roaming subscriber device using a short message service (SMS) to contact emergency services, wherein location information is obtained from a visited carrier network on which the originating subscriber device is roaming. An emergency SMS message is first routed to a predetermined emergency services SMSC. The emergency services SMSC then forwards data relevant to the emergency SMS message to an SMS to emergency services mediator. The SMS to emergency services mediator uses data received for the emergency SMS message to obtain location information therefor. Location information for an emergency SMS message is obtained from an LBS platform on a network carrier currently servicing the originating subscriber device. A next hop URI is then determined for the emergency SMS message based on relevant location information. The emergency SMS message is routed to the next hop URI and eventually routed to an appropriate PSAP.

The present invention claims priority from U.S. Provisional No. 61/645,366, filed May 10, 2012, entitled “Method for Determining the Location of a Roaming Subscriber Device using SMS for Emergency Purposes”, the entirety of which is expressly incorporated herein by reference.

### BACKGROUND OF THE INVENTION

1. Field of the Invention

This invention relates generally to telecommunications. More particularly, it relates to messaging systems and emergency services.

2. Background

Short message service (SMS) is a text communication service that enables bidirectional transmission of short alphanumeric text messages to and from a Short Message Entity (i.e. a communication device or system capable of sending and receiving short messages (SMS messages)). Conventional SMS messages contain a maximum of 160 characters of text and are transmitted over digital wireless/mobile networks. Short message service (SMS) is currently the most widely used data application in the world.

Elements essential in providing short message service (SMS) include: a short message service center (SMSC), a short message service (SMS) gateway, and a mobile switching center (MSC).

A short message service center (SMSC) in an SMS network is responsible for the routing of SMS messages. In accordance with conventional SMS technology, a short message service center (SMSC) operates in a store- and-forward manner to guarantee delivery of SMS messages to intended message recipients, e.g., wireless devices, computer systems, etc. A short message service center (SMSC) communicates with external entities via a conventional short message peer to peer (SMPP) protocol.

An SMS gateway in an SMS network allows interconnectivity between short message service centers (SMSC) operating on different network carriers. In particular, each short message service center (SMSC) operates in accordance with a particular SMSC communication protocol. Moreover, short message service centers (SMSCs) on different network carriers may support different SMSC communication protocols. However, to enable inter-carrier text messaging, SMSCs on different network carriers must communicate with one another to ensure proper message routing. Therefore, to enable inter-carrier text messaging, SMS gateways translate between SMSC communication protocols supported on different network carriers.

In accordance with conventional SMS technology, each SMS network contains at least one mobile switching center (MSC). A mobile switching center (MSC) performs switching and call control functions on an SMS network, and transfers SMS messages between a short message service center (SMSC) and a mobile station (MS), e.g., a subscriber device, etc.

Moreover, an SMS network typically includes a location based services (LBS) platform to enable location determination for subscriber devices.

In accordance with conventional SMS technology, short message service (SMS) entities communicate with one another via Signaling System Number 7 (SS7) signaling protocols. In an SS7 system, information is sent back and forth between network entities in SS7 messages (i.e. digital packets). Network entities communicating via SS7 are identified via unique point codes (i.e. unique identifiers). A set of unique point codes is included in each SS7 message to identify a source and a destination node for that message. For example, an originating point code (OPC) is included in an SS7 message to identify a source node (i.e. originating node) on which that SS7 message was originated.

Due to an overwhelming implementation of the short message service (SMS), wireless subscribers often assume that SMS messages may be used to contact emergency services. While this is not yet the case in all areas, the federal communications commission (FCC) has recently required that all wireless carriers begin efforts to support text to 911 services (in addition to standard voice to 911 services). A text to 911 service allows subscribers to send text messages to public safety answering points (PSAPs) (i.e. 911 call centers) to request emergency services. Initial text to 911 deployments are to be SMS based solutions (i.e. SMS to 911 solutions).

SMS to 911 services are projected to be exceptionally beneficial to the hard of hearing and exceptionally beneficial in situations where voice conversation is not possible and/or not desirable.

SMS to 911 is not yet a fully standardized call flow, and there are currently many different approaches. However, while many solutions have been proposed for providing SMS to 911 services, there are currently no known solutions for determining a location of a device requesting SMS to 911 services while roaming.

In particular, when a subscriber device (i.e. a device subscribed to services provided by a network carrier) issues an emergency services bound SMS message (e.g. an SMS to 911 message) on a network carrier that is not the device's home/direct network carrier (i.e. the device is roaming), any attempts to determine location information for that roaming subscriber device will fail, because SMS to 911 messages conventionally proceed (via a short message peer to peer (SMPP) protocol) from a short message service center (SMSC) on a device's home network carrier (even when that device is being service by a visited network carrier).

If location information cannot be obtained for a device that initiates an SMS to 911 request, then that SMS to 911 request is less likely to be routed to an appropriate public safety answering point (PSAP) (e.g. a public safety answering point (PSAP) within closest geographic proximity to an originating subscriber device). Since emergency service requests are typically time sensitive, there exists a need for a method of location determination for roaming subscriber devices using SMS to contact emergency services.

### SUMMARY OF THE INVENTION

A method and apparatus for determining a location of a roaming subscriber device using a text communication service (e.g. a short message service (SMS)) to contact emergency services (e.g. 911 emergency services), comprises retrieving location information from a visited network carrier on which the subscriber device is roaming.

In accordance with the principles of the present invention, an SMS message addressed to emergency services (e.g. an SMS to 911 message) is routed to a predetermined emergency services short message service center (SMSC). The emergency services SMSC receives the emergency SMS message and sends pertinent data (i.e. a unique identifier for a serving mobile switching center (MSC), a unique identifier for an originating subscriber device, and a message body) extracted therefrom to an SMS to emergency services mediator. The SMS to emergency services mediator receives data for the emergency SMS message and then queries a location negotiator for relevant location information. Location information for an emergency SMS message is obtained from a location based services platform on a network carrier currently servicing the originating subscriber device.

Following location determination, a next hop uniform resource identifier (URI) is determined for the emergency SMS message based on location information obtained therefor. The emergency SMS message is routed to the next hop URI and eventually routed to an appropriate public safety answering point (PSAP) (i.e. 911 call center).

### BRIEF DESCRIPTION OF THE DRAWINGS

Features and advantages of the present invention become apparent to those skilled in the art from the following description with reference to the drawings:

FIG. 1 depicts an exemplary network structure for determining a location of a roaming subscriber device using a short message service (SMS) to contact emergency services, in accordance with the principles of the present invention.

FIG. 2 depicts exemplary location determination for a roaming subscriber device using a short message service (SMS) to contact emergency services, in accordance with the principles of the present invention.

### DETAILED DESCRIPTION OF ILLUSTRATIVE EMBODIMENTS

The present invention provides a method and apparatus for determining a location of a roaming wireless device using a short message service (SMS) to contact emergency services.

The present inventors appreciated that in conventional proposals for SMS to emergency services messaging (e.g. SMS to 911 messaging), attempts to retrieve location information for a device initiating SMS to emergency services while roaming, fail, because location information is conventionally requested from a device's home carrier network, even when that device is being serviced by a visited carrier network (i.e. roaming).

In accordance with the principles of the present invention, location information is obtained for a roaming subscriber device using a short message service to contact emergency services, from a visited carrier network on which that subscriber device is roaming (or being serviced by).

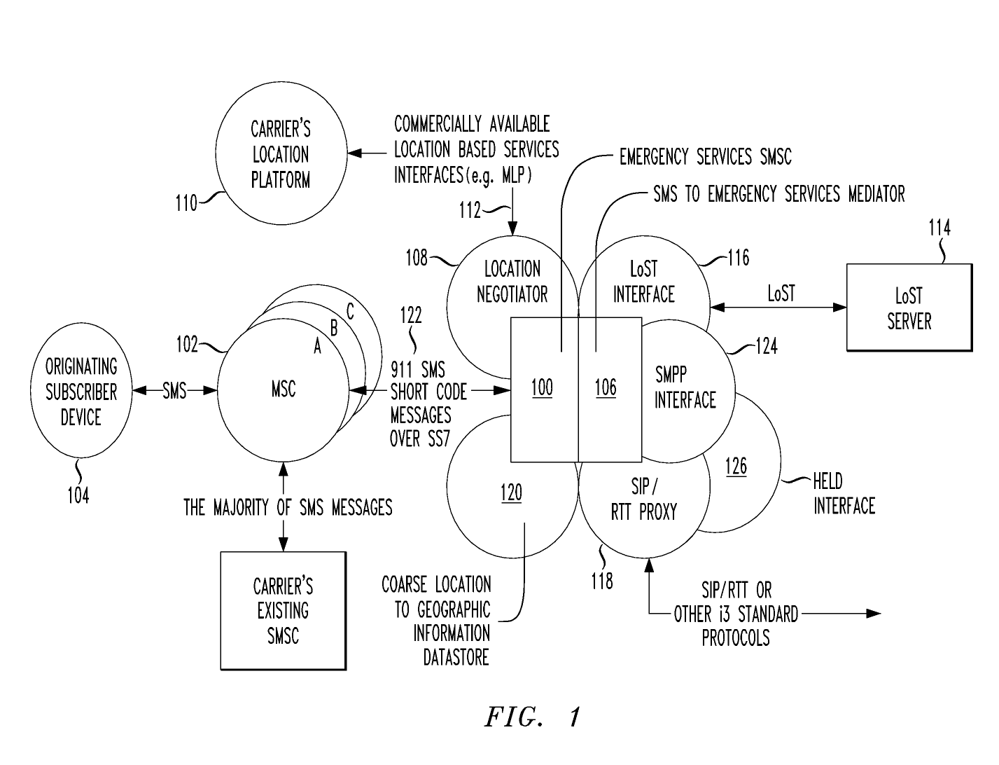

FIG. 1 depicts an exemplary network structure for determining a location of a roaming subscriber device using a short message service (SMS) to contact emergency services, in accordance with the principles of the present invention.

As depicted in FIG. 1, each carrier network comprises a predetermined emergency services short message service center (SMSC) 100 dedicated to servicing SMS to emergency service requests. In accordance with the principles of the present invention, all emergency SMS messages originated on a carrier network are routed (via a mobile switching center (MSC) 102 currently servicing an originating subscriber device 104) to that carrier network's emergency services SMSC 100. The emergency services SMSC 100 then routes data obtained for each emergency SMS message to an SMS to emergency services mediator 106, via a short message peer-to-peer (SMPP) interface 124.

In accordance with the principles of the present invention, the SMS to emergency services mediator 106 queries a location negotiator 108 for location information relevant to each emergency SMS message. As depicted in FIG. 1, the location negotiator 108 retrieves location information for an originating subscriber device 104 from a location based services platform 110 operating on that device's 104 serving carrier network (via a conventional location based services interface 112).

In accordance with the principles of the present invention, the SMS to emergency services mediator 106 obtains a next hop uniform resource identifier (URI) for each emergency SMS message dialogue, from a conventional Location-to-Service Translation (LoST) server 114 (via a conventional LoST interface 116). A LoST server 114 determines a next hop URI for an emergency SMS message based on location information retrieved therefor, along with a specified service uniform resource name (URN).

The SMS to emergency services mediator 106 sends an SMPP message, in accordance with a next hop URI obtained for each emergency SMS message dialogue, to a session initiation protocol (SIP)/real time text (RTT) proxy 118 (or any other SIP signaling protocol plus media protocol proxy, e.g., a SIP/Message Session Relay Protocol (MSRP) proxy, etc.) via the short message peer-to-peer (SMPP) interface 124. The SIP/RTT proxy 118 (or other standard i3 protocol proxy, such as SIP/MSRP) then sends a SIP/RTT INVITE message to the identified next hop URI. A SIP/RTT INVITE message may contain a location by reference, accessible via a location dereference interface, e.g., a HELD interface 126, or a location by value.

As depicted in FIG. 1, the SMS to emergency services mediator may also query a coarse location to geographic information datastore 120 for geographic location information, when location information received for an emergency SMS message is non-geographic.

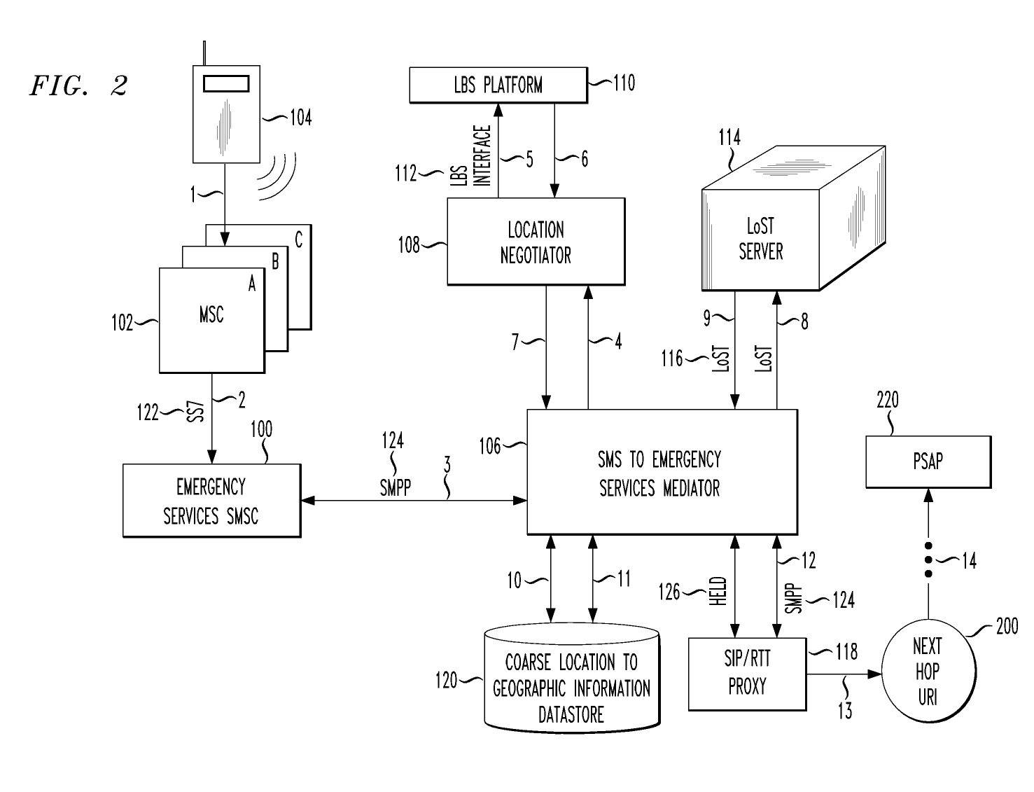

FIG. 2 depicts exemplary location determination for a roaming subscriber device using a short message service (SMS) to contact emergency services, in accordance with the principles of the present invention.

In particular, as depicted in step 1 of FIG. 2, a subscriber device (i.e. a device subscribed to services provided by a wireless network carrier) 104 initiates an SMS to emergency services request by addressing an SMS message (a digital message) to an appropriate emergency services short code (e.g. ‘911’).

As portrayed in step 2 of FIG. 2, a mobile switching center (MSC) 102 on a carrier network currently servicing the originating subscriber device 104, uses short message peer to peer (SMPP) protocol over signaling system number 7 (SS7) protocol 122 to directly route the SMS message addressed to emergency services to a predetermined emergency services short message service center (or SMS gateway) 100. The emergency services SMSC 100 receives the SMS message (in an SS7 message) from the MSC 102 servicing the originating subscriber device 104, and identifies therein: an E.164 (i.e. a unique number identifier) affiliated with the originating subscriber device 104, an originating point code (OPC) (i.e. a unique identifier) identifying the serving mobile switching center (MSC) 102, and the body of the initiated emergency SMS message.

In step 3, the emergency services SMSC 100 sends the E.164, the originating point code (OPC) (identifying the serving MSC 102), and the emergency SMS message body to an inventive SMS to emergency services mediator 106, via an SMPP interface 124.

In step 4, the SMS to emergency services mediator 106 receives data from the emergency services SMSC 100, and forwards the E.164 (affiliated with the originating subscriber device 104) and the originating point code (identifying the serving mobile switching center (MSC) 102) to an inventive location negotiator 108.

As depicted in step 5, the location negotiator 108 queries a location based services platform 110 on the serving carrier network (i.e. the carrier network currently servicing the originating subscriber device 104) for relevant location information, via a conventional location based services interface (e.g. a mobile location protocol (MLP)) 112. The location negotiator 108 determines a location based services platform 110 to query, based on an association between the originating point code (OPC) received for the serving MSC 102 and connection information retrieved for the serving location based services platform.

As depicted in step 6, the location based services platform 110 on the serving carrier network returns a query response to the location negotiator 108, containing location information in accordance with a particular type of location requested.

As portrayed in step 7, the location negotiator 108 returns location information obtained for the originating subscriber device 104 to the SMS to emergency services mediator 106.

In step 8, the SMS to emergency services mediator 106 forwards received location information to a standards based LoST server 114, via a conventional LoST interface 116.

As depicted in step 9, the LoST server 114 determines a next hop uniform resource identifier (URI) 200 for the emergency services SMS message, based on location information received for the originating subscriber device 104. The LoST server 114 then returns the next hop URI 200 to the SMS to emergency services mediator 106.

If location information received for the originating subscriber device 104 is non-geographic (e.g. a name of a park, museum, etc., as opposed to an address or geographic coordinate), then the SMS to emergency services mediator 106 queries a coarse location to geographic information data store 120 for corresponding geographic information, as depicted in step 10. The coarse location to geographic information data store 120 then returns requested geographic location information, e.g., location coordinates, etc., to the SMS to emergency services mediator 106 (step 11).

In step 12, the SMS to emergency services mediator 106 sends the body of the original emergency SMS message, the E.164 affiliated with the originating subscriber device 104, and location information retrieved for the originating subscriber device 104 (or a referenced data object pointing to location information) to a session initiation protocol (SIP) plus real time text (RTT) protocol over real time protocol (RTP) proxy 118 (or any other SIP signaling protocol plus media protocol proxy, e.g. a SIP/MSRP proxy), via the SMPP interface 124.

As depicted in step 13, the SIP/RTT proxy 118 subsequently sends a SIP/RTT INVITE message (i.e. a message requesting that a client partake in a session) to the next hop URI 200 previously selected for the emergency SMS message. The SIP/RTT INVITE message either contains a location by reference (in which the reference is to a record maintained by the SMS to emergency services mediator 106, and accessible via a location dereference interface, e.g., a HELD interface 126) or a location by value (using an internet engineering task force (IETF) (i.e. IETF RFC4119) presence information data format-location object (PIFD-LO)).

As depicted in step 14, each emergency SMS message is eventually routed to an appropriate public safety answering point (PSAP) (i.e. a 911 call center) 220.

The present invention has particular applicability to wireless carriers, and other SMS to emergency services type application providers.

While the invention has been described with reference to the exemplary embodiments thereof, those skilled in the art will be able to make various modifications to the described embodiments of the invention without departing from the true spirit and scope of the invention.

What is claimed is:

1. A method of determining a location of a roaming subscriber device using a short message service (SMS) to contact emergency services, comprising:
receiving an emergency SMS message on an emergency services SMSC;
forwarding information regarding said emergency SMS message to an SMS to emergency services mediator;
obtaining location information for said emergency SMS message;
determining a uniform resource identifier (URI) for said emergency SMS message based on said location information; and
sending said emergency SMS message to said URI.

2. The method of determining a location of a roaming subscriber device using a short message service (SMS) to contact emergency services according to claim 1, wherein:
said emergency services SMSC receives said emergency SMS message from a mobile switching center (MSC) servicing a roaming subscriber device initiating said emergency SMS message.

3. The method of determining a location of a roaming subscriber device using a short message service (SMS) to contact emergency services according to claim 1, wherein said information regarding said emergency SMS message includes:
a unique identifier for a roaming subscriber device initiating said emergency SMS message;
an originating point code (OPC) for an MSC servicing said roaming subscriber device; and
a body of said emergency SMS message.

4. The method of determining a location of a roaming subscriber device using a short message service (SMS) to contact emergency services according to claim 1, wherein:
said URI is a next hop uniform resource identifier (URI).

5. The method of determining a location of a roaming subscriber device using a short message service (SMS) to contact emergency services according to claim 1, wherein:
said location information for said emergency SMS message is obtained from a location based services platform on a carrier network currently servicing a roaming subscriber device initiating said emergency SMS message.

6. An apparatus for determining a location of a roaming subscriber device using a short message service (SMS) to contact emergency services, comprising:
means for receiving an emergency SMS message on an emergency services SMSC;
means for forwarding information regarding said emergency SMS message to an SMS to emergency services mediator;
means for obtaining location information for said emergency SMS message;
means for determining a uniform resource identifier (URI) for said emergency SMS message based on said location information; and
means for sending said emergency SMS message to said URI.

7. The apparatus for determining a location of a roaming subscriber device using a short message service (SMS) to contact emergency services according to claim 6, wherein:
said means for receiving receives said emergency SMS message from a mobile switching center (MSC) servicing a roaming subscriber device initiating said emergency SMS message.

8. The apparatus for determining a location of a roaming subscriber device using short message service (SMS) to contact emergency services according to claim 6, wherein said information regarding said emergency SMS message includes:
a unique identifier for a roaming subscriber device initiating said emergency SMS message;
an originating point code (OPC) for an MSC servicing said roaming subscriber device; and
a body of said emergency SMS message.

9. The apparatus for determining a location of a roaming subscriber device using short message service (SMS) to contact emergency services according to claim 6, wherein:
said URI is a next hop uniform resource identifier (URI).

10. The apparatus for determining a location of a roaming subscriber device using short message service (SMS) to contact emergency services according to claim 6, wherein:
said means for obtaining location information for said emergency SMS message obtains location information from a location based services platform on a carrier network currently servicing a roaming subscriber device initiating said emergency SMS message.
